(19) United States
(12) Patent Application Publication
(10) Pub. No.: US 2012/0008689 A1
(43) Pub. Date: Jan. 12, 2012

(54) FRAME INTERPOLATION DEVICE AND METHOD

(76) Inventors: Osamu NASU, Tokyo (JP); Yoshiki Ono, Tokyo (JP); Toshiaki Kubo, Tokyo (JP); Koji Minami, Tokyo (JP)

(21) Appl. No.: 13/071,851

(22) Filed: Mar. 25, 2011

(30) Foreign Application Priority Data
Jul. 6, 2010 (JP) 2010-153560
Nov. 2, 2010 (JP) 2010-246042

(51) Int. Cl. H04N 7/26

(52) U.S. Cl. 375/240.16; 375/E07.104

(57) ABSTRACT

To interpolate a frame between two frames of a video signal, sets of reference images are generated, each set having a different resolution level. Motion between the two frames is estimated at each resolution level by using these sets of reference images. For each pixel processed at each resolution level, multiple motion vector candidates are obtained. Information indicating the multiple motion vector candidates is used to select motion search ranges at the next higher resolution level. To determine the motion search range for a pixel, selected motion vector candidates pertaining both to the pixel itself and to its neighboring pixels are used. An interpolated frame of high image quality is thereby obtainable without increased computation and with reduced risk of major image defects due to erroneous motion estimation.

### BACKGROUND OF THE INVENTION

1. Field of the Invention

The present invention relates to a frame interpolation device and method for generating an interpolated image between two consecutive frames by using a plurality of frame images included in a video signal, and further relates to a program for implementing the frame interpolation method and a recording medium in which the program is stored.

2. Description of the Related Art

Liquid crystal television sets and other image display apparatus of the hold type continue to display the same image for one frame period. A resulting problem is that the edges of moving objects in the image appear blurred, because while the human eye follows the moving object, its displayed position moves in discrete steps. One possible countermeasure is to smooth out the motion of the object by interpolating frames, thereby increasing the number of displayed frames, so that the displayed positions of the object change in smaller discrete steps as they track the motion of the object.

A related problem, referred to as judder, occurs when a television signal is created by conversion of a video sequence with a different frame rate, or a video sequence on which computer processing has been performed, because the same image is displayed continuously over two or more frames, causing motion to be blurred or jerky. This problem can also be solved by interpolating frames, thereby increasing the number of displayed frames.

Pre-existing methods of generating interpolated frames include the zero-order hold method, which interpolates an image identical to the preceding frame, and the mean value method, in which the interpolated frame is the average of the preceding and following frames. The zero-order hold method, however, is unable to display smooth motion because it interpolates the same image, leaving the problem of blur in hold-type displays unsolved. With the mean value interpolation method, there is the problem of double images.

A method of generating an interpolated frame to enable a more natural display is to generate each interpolated pixel in the interpolated frame from the most highly correlated pair of pixels in the preceding and following frames that are in point-symmetric positions, with the interpolated pixel as the center of symmetry (as in Patent Document 1, for example). With this method, however, since correlation is detected locally, on a pixel basis, there is the possibility of selecting the wrong pixel pair, and an accurate interpolated image may not be obtained.

The problem of local correlation detection can be solved by setting a window centered on each pixel and taking the correlation between all pixels included in the window, instead of just comparing pixels on the preceding and following frames. Setting a window on each pixel and calculating the correlation, however, involves a tremendous amount of computation. It has therefore been proposed to generate reduced images and calculate correlations in progressively limited ranges (as in Patent Document 2, for example).

Patent Document 1: Japanese Patent Application Publication No. 2006-129181

Patent Document 2: Japanese Patent Application Publication No. 2005-182829

A problem in the above progressive method of frame interpolation is that motion estimation errors made in one stage propagate through subsequent stages, making an accurate final motion estimate impossible. Motion estimation errors are particularly likely to occur in repeating patterns, or at the boundaries between regions of differing motion. Such motion estimation errors degrade the image quality of the generated interpolated frame, sometimes causing major image defects.

### SUMMARY OF THE INVENTION

An object of the present invention is to determine motion vectors between frames efficiently and accurately, in order to generate interpolated frames of high image quality for a video picture.

In a frame interpolation apparatus for generating an interpolated frame between a first frame and a second frame in a video signal, the second frame temporally preceding the first frame, a frame interpolation apparatus according to an embodiment of the invention includes:
a reference image generator for receiving image signals of the first frame and the second frame and generating therefrom a plurality of sets of reference images, the reference images in each one of the sets having mutually identical resolution, the reference images in different ones of the sets having different resolutions;
a motion estimation unit for performing motion estimation based on the plurality of sets of reference images; and
an interpolated frame generator for generating an image signal of the interpolated frame, each pixel on the interpolated frame being based on at least one motion vector candidate obtained as a result of motion estimation performed by the motion estimation unit using the set of reference images of highest resolution.

The motion estimation unit generates information representing results of motion estimation by proceeding sequentially from motion estimation using the reference images of lowest resolution to motion estimation using the reference images of highest resolution.

In performing motion estimation by using the reference images of each resolution, the motion estimation unit determines a search range, for each pixel processed on the second frame, by using information indicating a motion vector candidate obtained for that pixel as a result of motion estimation performed using the set of reference images of next lower resolution, and also using information indicating a motion vector candidate obtained for a pixel neighboring that pixel as a result of motion estimation performed using the set of reference images of the next lower resolution.

According to the present invention, it is possible to mitigate the occurrence of major motion estimation errors in repeating patterns and at the boundaries between regions of differing motion in interpolated frames, to increase motion estimation accuracy, and to generate interpolated frames of high image quality.

### BRIEF DESCRIPTION OF THE DRAWINGS

In the attached drawings:

FIG. 1 is a block diagram illustrating the structure of a frame interpolation apparatus in an embodiment of the invention;

FIG. 2 shows a reference image pyramid PG;

FIG. 3 is a block diagram illustrating an exemplary structure of the reference image generator 20 in FIG. 1;

FIG. 4 is a flowchart illustrating a process for configuring the reference image pyramid;

FIG. 5 illustrates image reduction based on averaging;

FIG. 6 is a block diagram illustrating an exemplary structure of the multi-resolution motion estimator 40 in FIG. 1;

FIG. 7 illustrates pixel blocks and their representative pixels;

FIG. 8 shows windows used for a similarity calculation;

FIG. 9 shows an exemplary similarity table;

FIG. 10 illustrates motion estimation on a twice-reduced image;

FIG. 11 illustrates motion estimation on a once-reduced image, based on a higher-level similarity table;

FIG. 12 illustrates motion estimation on an image of the input image size, based on a higher-level similarity table;

FIG. 13 is a flowchart illustrating the multi-resolution interframe motion estimation process;

FIG. 14 is a block diagram illustrating an exemplary structure of the motion compensating interpolated frame generator 60 in FIG. 1;

FIG. 15 is a flowchart illustrating the motion compensating interpolation frame generation process;

FIG. 16 illustrates motion according to a motion vector;

FIG. 17 shows an example of motion vector collision;

FIG. 18 illustrates vacancies left by motion vectors;

FIG. 19 illustrates interpolation of a motion vector based on motion vectors of eight neighboring points adjacent to a vacancy;

FIG. 20 shows how reference image positions in the first and second reference frames FA and FB are determined from a motion vector;

FIG. 21 shows how the value of a pixel in the interpolation frame FH is determined from the reference pixels in the first and second reference frames FA and FB;

FIG. 22 illustrates motion estimation using a three-frame set of reference images;

FIG. 23 is a block diagram illustrating a variation of the structure of the frame interpolation apparatus;

FIG. 24 is a block diagram illustrating an exemplary structure of the multi-resolution motion estimator 40b in a second embodiment of the invention;

FIG. 25 is a flowchart illustrating processing by the motion vector candidate information selectors in FIG. 24;

and

FIG. 26 is a block diagram illustrating an exemplary structure of the multi-resolution motion estimator 40c in a third embodiment of the invention.

### DETAILED DESCRIPTION OF THE INVENTION

### First Embodiment

A first embodiment of the invention will be described below with reference to the attached drawings.

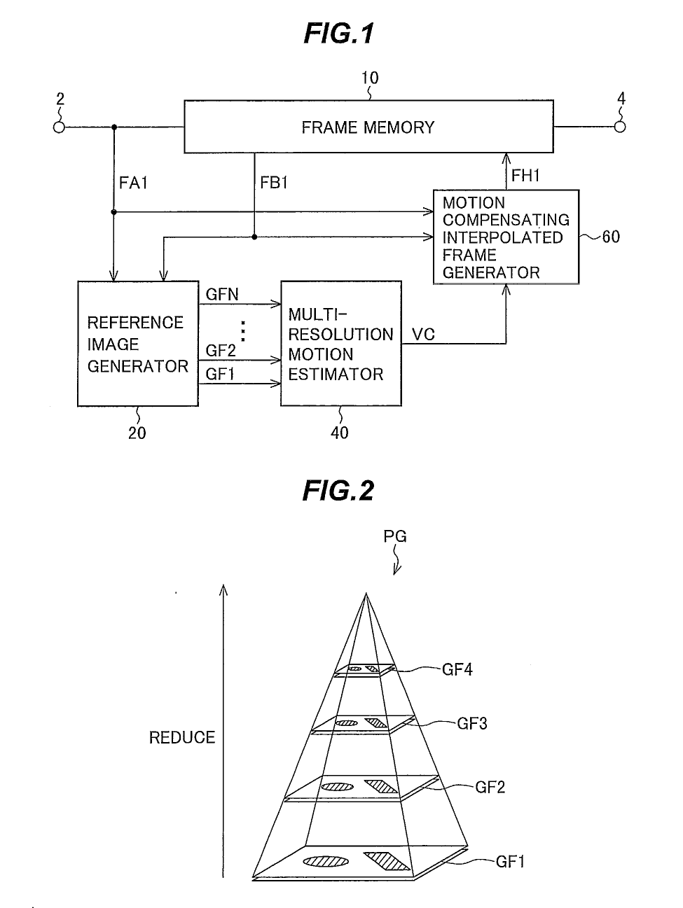

FIG. 1 is a block diagram of a novel frame interpolation apparatus. In the illustrated frame interpolation apparatus, an input video signal VI is received at a video signal input terminal 2, and after interpolation, a video signal VO is output from a video signal output terminal 4.

The input video signal VI is supplied to a frame memory 10, a reference image generator 20, and a motion compensating interpolated frame generator 60 as a non-reduced image signal FA1 representing the original image of a first reference frame.

The frame memory 10 accumulates the original images FA1 of successive first reference frames FA. After the elapse of one frame interval, the image signal (non-reduced image signal) FA1 written in the frame memory 10 is read out as the image signal (non-reduced image signal) FB1 of the frame (the second reference frame) FB one frame interval before and supplied to the reference image generator 20 and motion compensating interpolated frame generator 60.

The reference image generator 20 receives the non-reduced image signals FA1 and FB1 of the first reference frame FA and second reference frame FB and carries out an iterative reduction process to generate reduced image signals FA2 to FAN and FB2 to FBN. Both the non-reduced images FA1 and FB1 and the reduced images FA2 to FAN and FB2 to FBN are used as reference images. Reference images FAn and FBn form a reference image pair or set GFn (where n is an integer from 1 to N). Reference images in different pairs have different resolutions, and the reference images in the same pair have the same resolution.

If the reference image pairs GF1 to GFN are arranged from bottom to top in order of resolution, and thus in order of screen size (number of pixels), they have the appearance shown in FIG. 2 (N=4 in FIG. 2), so the entire collection of reference image pairs GF1 to GFN is referred to as a reference image pyramid PG, and the reference image pairs GF1 to GFN constituting the pyramid PG are referred to as levels. Since the pair of images with the lowest resolution is situated at the top, it is referred to as the top level, and the levels are also referred to by numbers n (from 1 to N), the n-th level being the n-th in order from the top. The n-th level accordingly consists of the (N-n+1)-th reference image pair.

A multi-resolution motion estimator 40 receives the reference image pyramid PG, estimates motion between the first reference frame FA and second reference frame FB, and outputs estimated results VC.

The multi-resolution motion estimator 40 estimates motion progressively, in stages. Progressive motion estimation means that after motion is estimated using the reference images with the lowest resolution, motion estimation proceeds in order up to the reference images with the highest resolution; when progressive motion estimation is carried out in the present invention, information indicating the estimation results is successively generated and updated, and information indicating a plurality of motion vector candidates obtained as the results of motion estimation performed using the pair of reference images of each resolution (motion vector candidates estimated from the reference images at each resolution) is used to determine the search ranges when motion estimation is performed using the pairs of reference images with higher resolutions.

The motion compensating interpolated frame generator 60 generates an interpolated image FH1 based on reference image pair GF1 and the motion estimation results VC from the multi-resolution motion estimator 40. The interpolated image FH1 thereby generated is stored in the frame memory 10, being inserted between reference images FA1 and FB1, and reference images FA1 and FB1 and the interpolated image FH1 are output in time sequential order from the video signal output terminal 4.

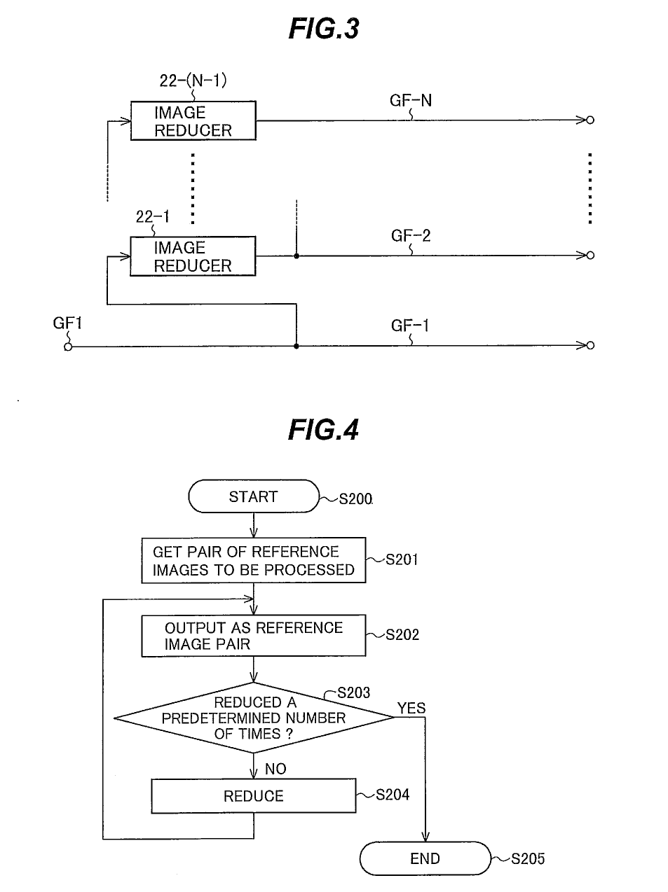

FIG. 3 shows an example of the reference image generator 20. The illustrated reference image generator 20 has a series of (N−1) image reducers 22-1 to 22-(N−1), each of which reduces an input image and outputs the reduced image.

The initial image reducer, that is, the first image reducer 22-1, receives and reduces the first reference image pair GF1 and outputs the second reference image pair GF2.

The image reducer in each stage after the first, that is, the n-th image reducer 22-n (where n is from 2 to (N−1)) reduces the n-th reference image pair GFn output from the image reducer in the preceding stage, that is, from the (n−1)-th image reducer 22-(n−1), and outputs the (n+1)-th reference image pair GF(n+1).

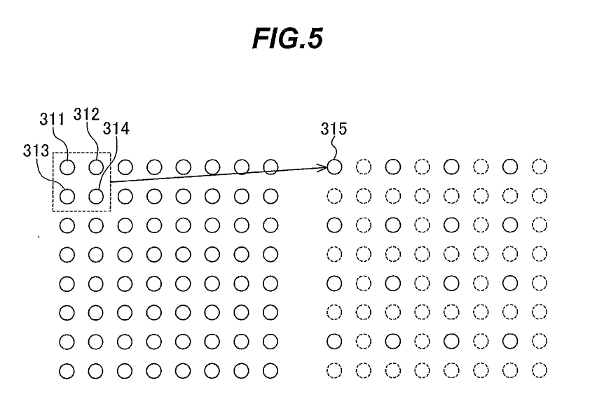

FIG. 4 illustrates the process carried out in the reference image generator 20 to construct the reference image pyramid. The input reference image pair GF1 is output without alteration as the reference image pair GF1 at the original resolution (S201, S202).

Reference image pair GF1 is also reduced by image reducer 22-1 (S204) and output as reduced reference image pair GF2 (S202). Reduced reference image pair GF2 is sent to the next image reducer 22-2 and reduced again. Reduction processing and output are repeated (S203) in like manner. Reference image pairs GF1 to GFN with a plurality of resolutions, including the original resolution, are thereby output. The number of times the reduction process is carried out is one less than the number of levels.

The image reducers 22-1 to 22-(N−1) perform reduction processing by, for example, treating a certain number of pixels as a single unit and taking their mean value as a pixel value in the new image. FIG. 5 shows an example in which mean values of four pixels are taken to reduce a reference image by a factor of two vertically and horizontally. The mean value of four mutually adjacent pixels 311 to 314 is taken as the value of a new pixel 315. The reduced image is obtained by taking such mean values for all pixels. The reduction process can also be carried out by simple decimation, or by taking median or mode values instead of mean values.

The mean value reduction process has a low-pass filter effect and can be expected to prevent aliasing. It is also possible to confine the image processing to a low spatial frequency region. It accordingly becomes possible to obtain stable approximate motion estimates from the reduced reference image pairs.

When the reference image pyramid is constructed in the present embodiment, the image reduction ratio (referred to below as the level-to-level reduction ratio) in a single image reduction process is ¼ (½ vertically and ½ horizontally), and the reduction process is carried out twice.

The number of levels can be increased to enable the estimation of larger amounts of motion, or conversely, the number of levels can be decreased to reduce the amount of computation, and the level-to-level reduction ratio can be altered to fit the motion estimation accuracy.

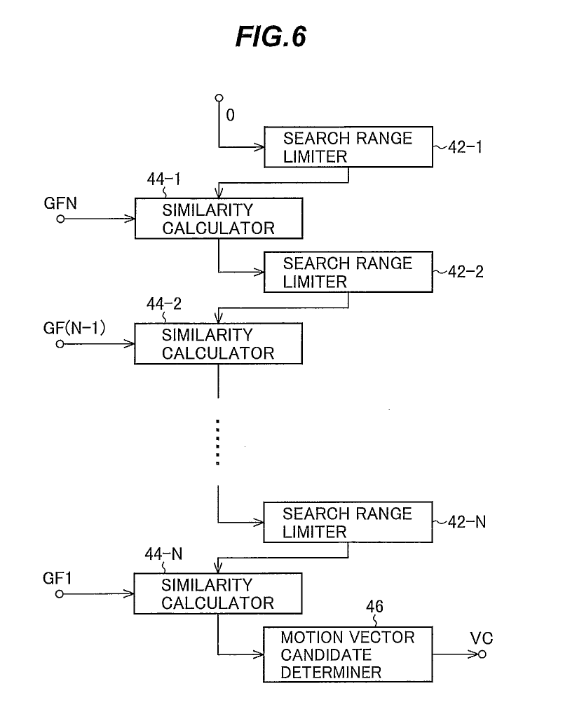

FIG. 6 shows an example of the multi-resolution motion estimator 40.

The illustrated multi-resolution motion estimator 40 has first to N-th search range limiters 42-1 to 42-N forming a plurality of stages, first to N-th similarity calculators 44-1 to 44-N likewise forming a plurality of stages, and a motion vector candidate determiner 46.

The similarity calculator in any particular stage, e.g., similarity calculator 44-n (where n is from 1 to N) inputs the corresponding reference image pair on the n-th level, which is the (N-n+1)-th reference image pair GF(N-n+1), and calculates the correlation, i.e., the similarity, of the reference images FA(N-n+1) and FB(N-n+1) constituting the pair. More specifically, it determines the correlations, i.e., similarities, between a pixel on the second reference image FB(N-n+1) (the pixel being processed) for which a motion vector is to be determined and pixels in a search range on the first reference image FA(N-n+1).

The search range limiter in each stage other than the initial stage, that is, the search range limiter 42-n (where n is from 2 to N) determines a search range based on similarity tables, described below, indicating the results of motion estimation by the similarity calculator in the preceding stage, that is, by the (n−1)-th similarity calculator 44-(n−1).

The search range limiter 42-1 in the initial stage is given an empty similarity table (indicated as ‘0’ in FIG. 6), because there is no similarity calculator in a preceding stage, and determines a certain range described below as the search range.

The n-th similarity calculator 44-n (n being from 1 to N) carries out similarity calculations on pixels corresponding to motion vector candidates in the search range determined by the n-th search range limiter 42-n, and performs motion estimation based on the calculated results. That is, by determining the similarity of pixel pairs including a pixel in the first reference frame FA and a pixel in the second reference frame FB, it determines the position (relative position) on the first reference frame FA to which each pixel in the second reference frame FB has moved.

If these similarities were to be determined for all pixels in the image frame at each resolution, however, the amount of computation would be immense, so the amount of computation is reduced by the use of a method of determining motion of pixel blocks each comprising a plurality of pixels.

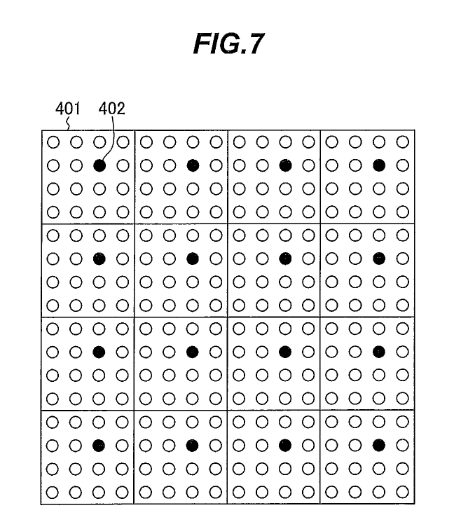

For example, the second reference frame FB is divided into pixel blocks, which are processed in turn, and the similarities between a representative point in the pixel block being processed and pixels in the first reference frame FA are calculated. FIG. 7 shows an image divided into 4×4 pixel blocks. Each circle in the drawing represents a pixel, and the black circles (e.g., circle 402) are the representative pixels in their respective pixel blocks (e.g., block 401).

When similarities are calculated for the representative pixel in each block, if the similarities were to be calculated by a simple comparison between pixels, the correlations would be too localized for accurate motion estimation, so the similarities between a reference window in the second reference frame FB, centered on the representative point, and reference windows in the first reference frame FA of the same size as the reference window in the second reference frame FB are calculated and used as the similarities between the representative points on the respective windows (the points on which the reference windows are centered). This technique is referred to as block matching.

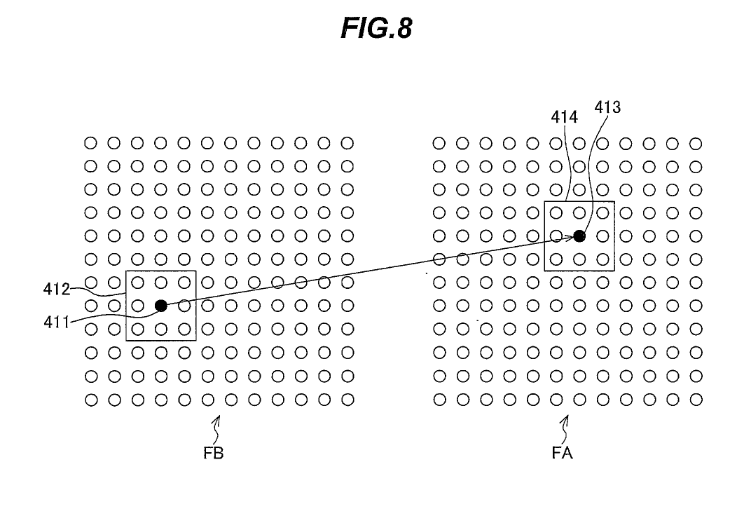

Specifically, as shown in FIG. 8, a window 412 centered on a pixel 411 at a representative point of a block on the second reference frame FB and a window 414 centered on a pixel 413 on the first reference frame FA are set, and a similarity is determined by using all of the pixels in these windows. The window size may be the same as the block size, or it may differ. Whereas the block size shown in FIG. 7 was 4×4 pixels, the window size in the example shown in FIG. 8 is 3×3 pixels.

A general method of calculating similarity is to calculate the total difference SAD (sum of absolute differences) between the pixel values (for example, the luminance values) of corresponding pixels in the windows. The relative position of the window with the smallest sum of absolute differences SAD can be taken as the estimated motion of pixel 411. Since the similarity is higher as the sum of absolute differences SAD is smaller, the similarity is the value of the sum of absolute differences SAD reversed in polarity with respect to a given threshold THR.

The similarity SML is therefore given as:

SML=THR−SAD

The result of motion estimation for pixel 411 is used as the result of motion estimation for the block having pixel 411 as its representative point, and the result of motion estimation for the block is also used as the result of motion estimation for all pixels in the block.

The size of the pixel blocks may differ from level to level, or may be the same on different levels. For example, if the size of the blocks on one level is h×v pixels, then the size of the blocks on another level having r times the resolution of that level vertically and horizontally may be rh×ry pixels, and all the pixels in each block on the one level may be included in the corresponding block on the other level, so that there is a one-to-one correspondence between the blocks on the two levels.

Alternatively, if the size of the blocks on the one level is h×v pixels, then the size of the blocks on the level having r times the resolution of that level vertically and horizontally may still be h×v pixels, and each block on the one level may be divided into r×r blocks on the other level, so that there is a one-to-(r×r) correspondence between the blocks on the two levels.

On each level, when the similarities between blocks are determined, the n-th similarity calculator 44-n (n being from 1 to N) carries out similarity calculations only for motion vectors in the search range determined by the n-th search range limiter 42-n. That is, the similarity calculator 44-n calculates the similarity between the representative point of each block in the second reference frame FB(N-n+1) in the (N-n+1)-th reference image pair GF(N-n+1) and each pixel in the search range determined by the n-th search range limiter 42-n in the first reference frame FA(N-n+1) (the similarity between reference windows centered on these pixels).

The similarities calculated by the n-th similarity calculator 44-n for (the representative point of) each block are used in the (n+1)-th search range limiter 42-(n+1) in its determination of the search range or ranges of the corresponding block or plurality of blocks.

If the blocks have different sizes on different levels and there is a one-to-one correspondence between the blocks on the n-th and (n+1)-th levels, then the similarity calculation results for each block on the n-th level are used to determine the search range for the corresponding single block on the (n+1)-th level.

If the blocks on different levels are of identical size and there is a one-to-(r×r) correspondence between the blocks on the n-th and (n+1)-th levels, then the similarity calculation results for each block on the n-th level are used to determine the search range for (r×r) blocks on the (n+1)-th level.

As the result of the motion estimation for each pixel carried out by use of the reference images of each resolution in the present embodiment, positional information (information indicating a relative position or motion vector) and related information indicating similarity are output not only for the pixel pair with the greatest similarity but also for a plurality of other pixel pairs; the collection of this information for a plurality of pixel pairs is generated or updated as a similarity table, and passed to the motion estimation processes carried out using the reference images on higher resolution levels. Since a plurality of motion vectors are determined as candidates in the motion estimation in the multi-resolution motion estimator 40, to distinguish them from the motion vectors ultimately used by the motion compensating interpolated frame generator 60, they will generally be referred to as motion vector candidates. The similarity tables generated or updated by the results of motion estimation carried out using the images of highest resolution are used in the generation of the interpolated frame.

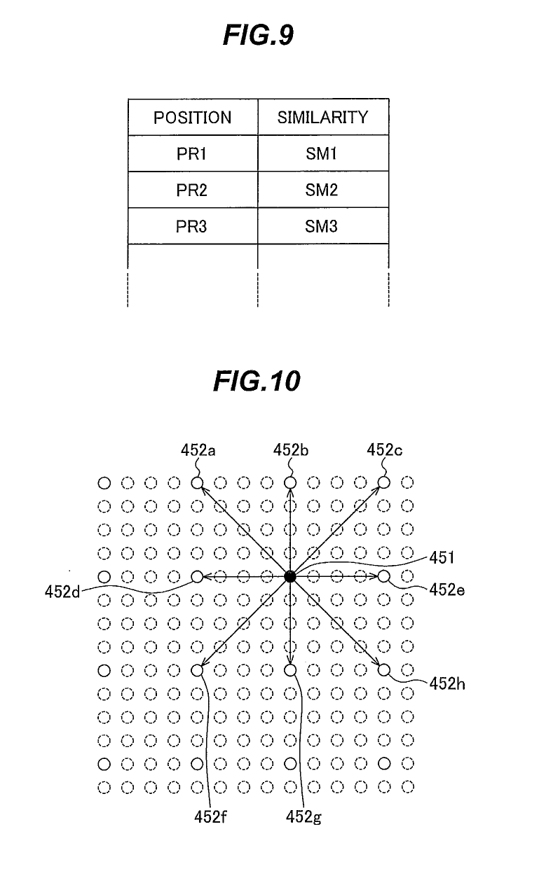

FIG. 9 shows an exemplary similarity table. The positional information given for each pixel pair represents, for example, the relative position of a pixel on the first reference frame FA in relation to a pixel on the second reference frame FB (the position to which the pixel being processed on the second reference frame has moved, based on a motion vector candidate), and information indicating the similarities calculated for these pixel pairs is given in relation to the positional information.

If the positional information written in the similarity table indicates relative position by numbers of pixels, these values must be scaled because of the different resolution on different levels. If the relative position (motion vector) on one level is (a, b), for example, the relative position on a level having a resolution that is r times higher vertically and horizontally becomes (ra, rb). The search range limiter 42-n on each level may write values that have been converted in this way into the similarity table it supplies to the next-stage similarity calculator 44-(n+1), or the search range limiter 42-n on each level may write values that have not yet been converted in this way into the similarity table it supplies to the next-stage similarity calculator 44-(n+1), and the next-stage similarity calculator 44-(n+1) may carry out the conversion. In the latter case, if the difference in resolution is known in advance, the similarity calculator 44-(n+1) may multiply the values by a coefficient corresponding to the resolution difference, or the search range limiter 42-n may supply information indicating the resolution of its own level together with the resolution table, and the similarity calculator 44-(n+1) may multiply the values by the ratio of the (preset) resolution of its own level to the resolution transmitted from the search range limiter 42-n.

The search range limiters 42-1 to 42-N carry out the search range determinations as follows. The search range limiters 42-2 to 42-N in the stages other than the initial stage set certain ranges centered on positions corresponding to one or two or more motion vector candidates estimated from the similarity calculations carried out by the preceding-stage similarity calculators 44-1 to 44-(N−1), for example, ranges within a given distance of these positions, as search ranges.

In the initial stage, since no similarity table is passed from the preceding stage, an empty table with values of ‘0’ is input. The result is that search range limiter 42-1 determines search ranges consisting of fixed ranges centered on representative points in the second reference frame FB: for example, ranges within a given distance of these points.

As stated above, the search range limiter 42-n (n being from 2 to N) in each stage other than the initial stage receives motion estimation results based on the results of the calculations performed by the similarity calculator 44(n−1) in the preceding stage in the form of similarity tables, from which it sets search ranges. For example, it may extract a predetermined number of pixel pairs from the similarity table of the pixel being processed, and set a predetermined range centered on the pixel on the first reference frame FA in each extracted pixel pair as a search range. The predetermined range is, for example, the range within a given distance of that pixel, e.g., a range of three pixels vertically and three pixels horizontally.

In the example described below, the method used to extract a predetermined number of pixel pairs from the similarity table of the pixel being processed is to select a predetermined number of pixel pairs with the highest similarity, e.g., the two pixel pairs with the highest similarity, but other methods are also contemplated, such as selecting maxima in the distribution of similarity values, or projecting the received similarity table onto the received image and taking the pixel values into consideration.

When each representative point is taken as the pixel being processed and a search range is determined for the pixel being processed, as the motion estimation results obtained by use of the reference image pair with the next lower resolution, in addition to using the similarity table summarizing information indicating the motion vector candidates estimated for the pixel being processed (the similarity table of the pixel being processed), it is also possible to use the similarity tables summarizing information indicating the motion vector candidates estimated for representative points neighboring the pixel being processed (for example, adjacent representative points), whereby the motion estimation accuracy can be further improved.

When the search range is set on the basis of the similarity tables for these neighboring representative points (the similarity tables of each of the neighboring representative points), a predetermined number of pixel pairs may be extracted from the similarity tables and a given range may be set as the search range, as was done with the similarity table of the pixel being processed.

FIGS. 10 to 12 show an example in which there are three levels, the level-to-level reduction ratio 1/r is ½ both vertically and horizontally, and the search ranges are 3×3 pixels. In these drawings, the pixels on the first reference frame FA and the pixels on the second reference frame FB are shown superimposed. The number of levels, the level-to-level reduction ratio, and the search range may be altered according to the processing power of the apparatus and the required estimation accuracy.

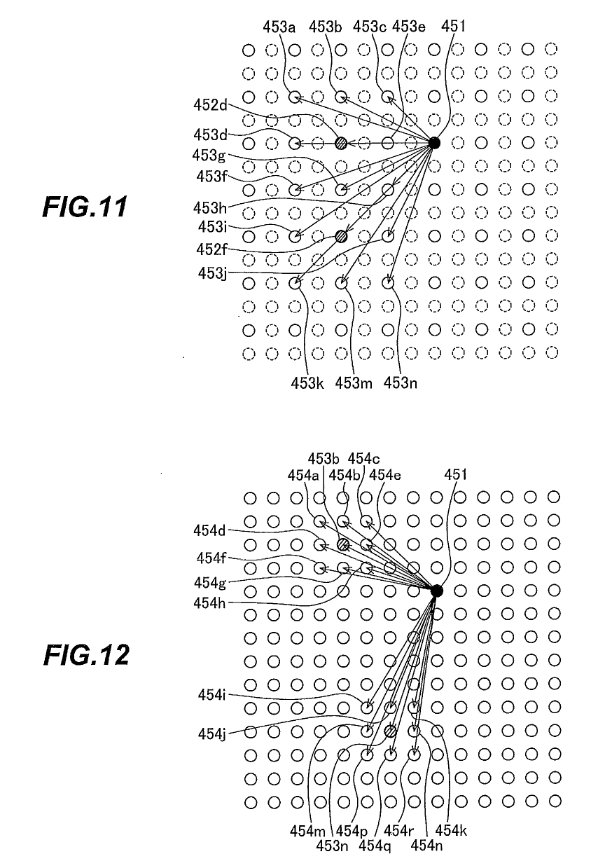

FIG. 12 shows the input image (the image with the original resolution), FIG. 11 shows the ¼ reduced image obtained by carrying out the reduction process once, and FIG. 10 shows the 1/16 reduced image obtained by carrying out the reduction process twice.

As stated above, ‘0’ is input to the initial-stage search range limiter 42-1, so the search range is a range centered on and within a given distance of the representative point which is the pixel being processed: for example, a 3×3 pixel range. Accordingly, with pixel positions 451 and 452a to 452h in the 3×3 pixel range centered on the pixel 451 on the first reference frame FA in the same position as the representative point 451 on the second reference frame FB in the 1/16 reduced image shown in FIG. 10 as the search range, similarity values are calculated for the nine pixel pairs formed by each of these pixels and the pixel at the representative point 451 on the second reference frame FB. Information indicating the similarity values obtained for the nine pixel pairs and their positional relations is stored in the similarity table of the pixel (451) being processed, and passed to the next stage shown in FIG. 11.

At the stage of the ¼ reduced image shown in FIG. 11, search range limiter 42-2 extracts a predetermined number of pixel pairs from the similarity table of the pixel (451) being processed, which was passed from the stage of the 1/16 reduced image shown in FIG. 10. In the example shown in FIG. 11, two pixel pairs are extracted, the pixels of the extracted pixel pairs on the first reference frame FA being the pixels indicated by reference characters 452d and 452f. Two given ranges, for example, 3×3 pixel ranges, centered on these pixels 452d and 452f are set as the search range to obtain pixel pairs including pixels 452d, 452f, and 453a to 453n on the first reference frame FA and the representative point 451 on the second reference frame FB.

The similarity table is now updated with information indicating the similarities and positional relationships of all the obtained pixel pairs, as in the stage of the 1/16 reduced image, and is passed to the next stage shown in FIG. 12.

Similarly, in the original resolution stage shown in FIG. 12, pixel pairs are extracted from the received similarity table, obtaining pixels 453b and 453n on the first reference frame FA. Two given ranges, for example, 3×3 pixel ranges, centered on these pixels are set as the search range to obtain pixel pairs including pixels 453b, 453n, and 454a to 454r on the first reference frame FA and the representative point 451 on the second reference frame FB. Finally, the similarity table is finalized by being updated with information indicating the similarity values and positional relations of all the obtained pixel pairs.

The motion vector candidate determiner 46 extracts a predetermined number of pixel pairs from the finalized similarity table as motion vector candidates. These pixel pairs are extracted by the same pixel pair extraction method as used by the search range limiters (42-2 to 42-N). Alternatively, the pixel pair extraction method used by the motion vector candidate determiner 46 may differ from the pixel pair extraction method used by the search range limiters (42-2 to 42-N).

For pixels at points other than the representative points on the second reference frame FB, the same motion vector candidates are used as for the representative point in the same pixel block.

In motion estimation using the reference image pair at each resolution level, when a search range is determined for each representative point (taken as the pixel being processed), the motion estimation accuracy can be further improved by using, as the motion estimation results obtained by use of the reference image pairs with the next lower resolution, the similarity tables summarizing information concerning the motion vector candidates estimated for representative points neighboring the pixel being processed (for example, adjacent representative points), in addition to using the similarity table summarizing information indicating the motion vector candidates estimated for the pixel being processed.

In this case, in detecting motion vectors by using the set of reference images at each resolution, as the search range for the pixel being processed in the second reference frame FB, the search range limiter 42-n, using the set of reference images with the next lower resolution, sets a region including a given range centered on each of the pixels on the first reference frame corresponding to the plurality of motion vector candidates estimated for the pixel being processed, in other words, a given range centered on the position to which the pixel being processed has moved according to each of the plurality of motion vector candidates, and a given range centered on each of the pixels on the first reference frame corresponding to the plurality of motion vector candidates estimated for the representative points neighboring the pixel being processed (the adjacent representative points, for example), in other words, a given range centered on the position to which the pixel being processed has moved according to each of this plurality of motion vector candidates.

Taking as an example the passing of similarity tables from the motion estimation process in the 1/16 reduced image shown in FIG. 10 to the motion estimation process in the ¼ reduced image shown in FIG. 11, if the adjacent representative points that are used are the four adjacent points above, below, to the left, and to the right, for example, not only the similarity table of the representative point (pixel being processed) 451 in the second reference frame FB in the 1/16 reduced image shown in FIG. 10 but also the similarity tables for representative points (pixels neighboring the pixel being processed) 452b, 452d, 452e, and 452g are passed and used to delimit the search range.

The similarity values calculated by the similarity calculator may also be modified by giving a weight to each of the similarity tables passed to the next level. In the passing of similarity tables from the motion estimation process for the 1/16 reduced image shown in FIG. 10 to the motion estimation process for the ¼ reduced image shown in FIG. 11, for example, the pixel pair similarities calculated by the similarity calculator may be multiplied by smaller weighting coefficients for the search ranges set by the similarity tables of representative points 452b, 452d, 452e, and 452g on the second reference frame FB than for the search ranges set by the similarity table of representative point 451 on the second reference frame FB, or the similarities calculated for the search ranges set by the similarity tables of representative points 452b, 452d, 452e, and 452g may be reduced by subtracting a predetermined value. Since representative points 452b, 452d, 452e, and 452g are neighboring representative points of representative point 451, a search that gives greater weight to the center than to the periphery can be carried out by subtracting a predetermined value from their similarities (more generally, greater weight can be given to motion estimates made for representative points closer to the representative point 451 representing the pixel being processed).

The search range set by the similarity table of each of the representative points 451, 452b, 452d, 452e, 452g in the second reference frame FB may also be weighted according to the highest similarity value that occurs in each similarity table (the maximum similarity value). By giving preference to similarity tables with high maximum similarity values in the search, it is possible to pass more reliable motion estimation results to the following stage.

The additional use of the similarity tables of neighboring representative points (for example, adjacent representative points) makes it possible to correct erroneous estimates by using accurate motion estimation results that have already been obtained, and accurate motion estimation near the boundary between two regions becomes possible, because in effect it becomes possible to refer to the motion of other adjacent pixels in the same area. As a result, major image defects near such boundaries in the interpolated frame FH can be effectively prevented. The use of neighboring information can also prevent erroneous motion estimation with respect to repeated patterns, a problem that occurs because when similar patterns are repeated, they cause high correlations to appear at positions having nothing to do with actual motion.

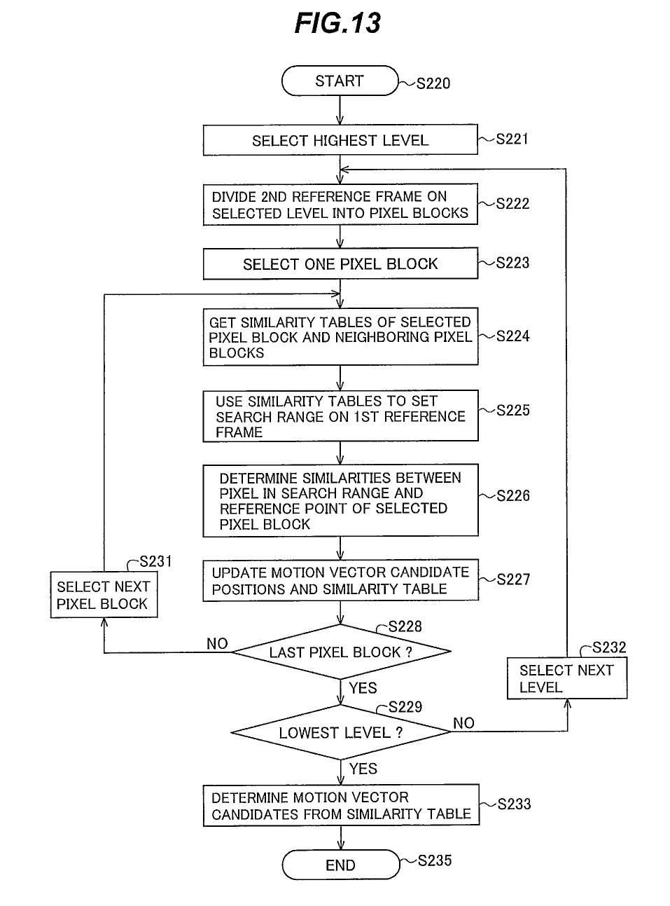

FIG. 13 illustrates the procedure by which the multi-resolution motion estimator 40 executes the motion estimation process.

After the process starts (S220), first the top level is designated as the level being processed (S221), and the second reference frame FB (the N-th reference image FBN) is divided into pixel blocks (S222).

Next, one of the plurality of pixel blocks generated by the dividing step is selected as the pixel block being processed (S223), and its similarity table (the similarity table of the representative point (the pixel being processed) in the pixel block being processed) and the similarity tables of its neighboring pixel blocks (the similarity tables of the representative points neighboring the pixel being processed) are obtained (S224). When the top level is processed, empty similarity tables are obtained. When a level other than the top level is processed, the similarity table of the pixel block being processed and the similarity tables of its neighboring pixel blocks are obtained from the next higher level.

Next a search range is set on the first reference frame FA, based on the similarity tables (S225), the similarities between the pixels in the search range and the representative point on the second reference frame FB (the similarities between windows centered on pixels in the search range and a window centered on the representative point) are derived (S226), and a similarity table in which relative positions and their corresponding similarities (the similarities calculated for the relative positions) are stored in mutual association is created or updated (S227).

Next a decision is made as to whether the pixel block being processed is the last pixel block on the second reference frame FB (S228), and if it is not the last pixel block, the next pixel block is selected (S231) and the process returns to step S224. When the first pixel block is selected in step S223, the block in the top left corner of the image, for example, is selected; when pixel blocks are selected in step S231, they are selected in order from the top left corner to the bottom right corner, for example, in which case the ‘last pixel block’ cited in step S228 is the block in the bottom right corner.

When the last pixel block is encountered, a decision is made as to whether the level that has just been processed is the lowest level (S229), and if it is not the lowest level, the next lower level (the level having the next higher resolution) is designated (S232) and the process returns to step S222.

Similar processing is then repeated.

When the lowest level is encountered in step S229, one or two or more motion vector candidates are taken from each of the most recent similarity tables (S233), and the process ends (S235).

As described above, at each stage in the multi-resolution motion estimator 40, a search range is set adaptively, on the basis of the similarity tables passed from the preceding stage (of motion estimation using reference images with lower resolution), whereby increasingly fine degrees of motion are estimated on the basis of the approximate motion estimated from reference image pairs of lower resolution, making it possible to reduce the total amount of motion estimation computation.

Instead of taking only one motion vector per pixel as the motion estimation result passed from each stage for use in the next stage (to estimate motion using the reference images with the next higher resolution), related data indicating the positional information and similarity of two or more pixel pairs for which similarity values were derived are collected in a similarity table at each stage and used in the next stage (to estimate motion using the reference images with the next higher resolution).

It is thus possible to avoid the propagation of erroneous estimates that result from limiting the motion estimation result at each stage to only one motion vector per pixel, avoid the defects resulting from the use of uniform motion vectors near boundaries, and suppress the occurrence of major image defects in the interpolated frame FH.

More specifically, when an erroneous motion estimation result is obtained at a low resolution stage, since subsequent estimation continues on the basis of the erroneous motion estimation result, the error may adversely affect subsequent estimation results, and at boundaries between two regions having different motion, a plurality of pixels having differing motion at the original resolution may be combined into a single pixel at a lower resolution stage, so with methods that derive only one motion estimation result per pixel and pass only that single result to the next stage, a motion estimation result for one pixel may also become the motion estimation result for other pixels, and since subsequent motion estimation continues on the basis of such motion estimation results, major image defects may occur near boundaries in the generated interpolated image FH.

In the present invention, the problems resulting from the limiting of the motion estimation results in each stage to a single motion vector can be solved by using the positional information and similarity information of two or more motion vectors per pixel obtained as the motion estimation result in each stage in motion estimation in the next stage, as described above.

The similarity tables may include data for all pixel pairs for which similarity values are obtained, as described above, or alternatively, a subset of these pixel pairs may be selected for inclusion in the similarity tables that are passed on. In this case, for example, a predetermined number of pixel pairs may be selected in order of their similarity values, pixel pairs with higher similarity values being selected first. The number of pixel pairs to be selected may be determined according to the required motion estimation accuracy.

Although information in table form (a similarity table) is passed from similarity calculator 44-n to search range limiter 42-(n+1) as the information indicating the motion estimation results in this embodiment, information indicating the motion estimation results (motion vector candidate information) may be passed in other forms.

The similarity calculators 44-n (n being from 1 to N) described above derive a sum of absolute differences SAD in order to calculate similarity values, but they may derive values other than a sum of absolute differences SAD; for example, weighted differences between pixel values may be obtained, differences in color difference information may be included as well as luminance values in the pixel values, and similarity values may also be calculated by including edge information given by first or second derivatives.

The window size may be set arbitrarily regardless of the pixel block size, and similarity may be calculated without using all the pixels in the window.

Next the motion compensating interpolated frame generator 60 will be described.

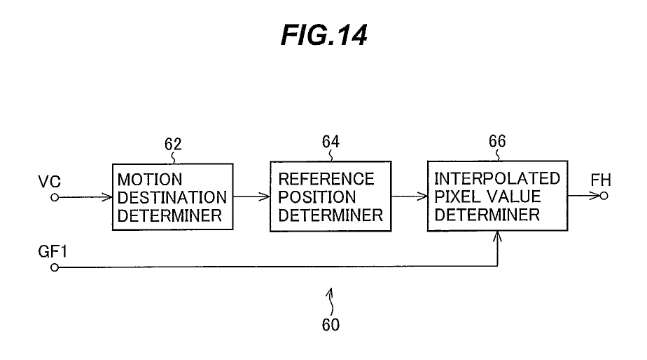

FIG. 14 is a block diagram of the motion compensating interpolated frame generator 60, which generates an interpolated frame FH from the motion vector candidates derived per block. The illustrated motion compensating interpolated frame generator 60 includes a motion destination determiner 62, a reference position determiner 64, and an interpolated pixel value determiner 66.

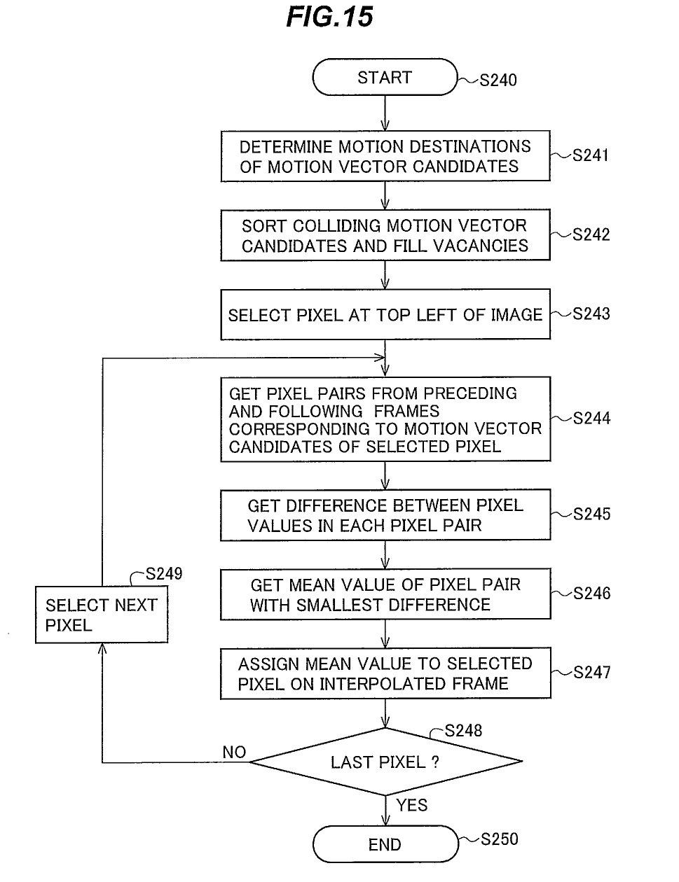

The insertion of a single interpolated frame FH between the first reference frame FA and second reference frame FB is illustrated in this embodiment as an example, but the invention may also be applied when two or more interpolated frames are inserted. FIG. 15 shows the procedure executed by the motion compensating interpolated frame generator 60 in FIG. 14 to generate an interpolated frame.

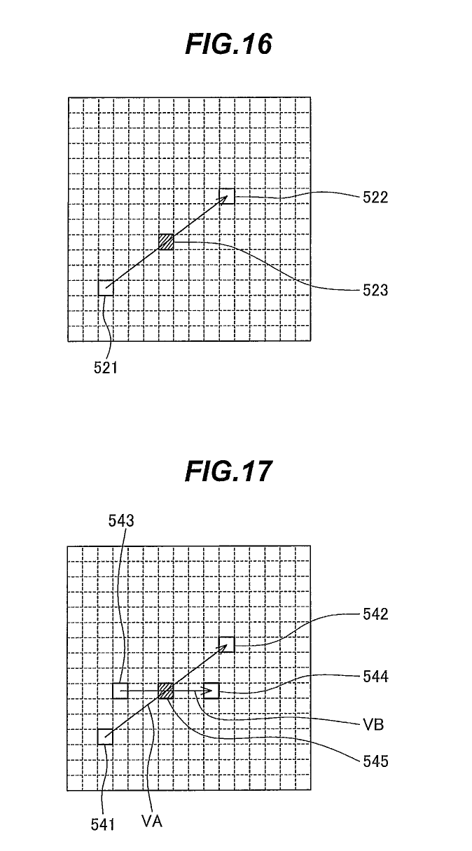

On the basis of the position of each pixel on the second reference frame FB and the motion vector candidates obtained for that pixel, the motion destination determiner 62 determines motion destinations for the pixel on the interpolated frame FH (S241). More specifically, as shown in FIG. 16, the midpoint 523 of the pixel position 521 on the second reference frame FB and the position 522 on the first reference frame FA which is the motion destination of the pixel at position 521 according to a motion vector candidate obtained for that pixel is taken as the motion destination on the interpolated frame FH according to that motion vector candidate of the pixel at position 521.

When motion destinations are determined by this method, ‘collisions’ may occur in which a single pixel position on the interpolated frame FH is the motion destination given by a plurality of motion vector candidates on the second reference frame FB, and ‘vacancies’ may occur in which a pixel position on the interpolated frame FH is not the motion destination according to any motion vector candidate on the second reference frame FB. A process is therefore performed to deal with these situations (S242).

FIG. 17 illustrates a collision. In this illustration, a pixel at a pixel position 541 on the second reference frame FB has a motion vector candidate VA pointing to a pixel position 542 on the first reference frame FA, a pixel at a pixel position 543 on the second reference frame FB has a motion vector candidate VB pointing to a pixel position 544 on the first reference frame FA, and pixel position 545 in the interpolated frame FH is the motion destination given by both motion vector candidates VA and VB, causing a collision. When the number of motion vector candidates colliding in this way exceeds a predetermined number, the predetermined number of motion vector candidates are selected in descending order of similarity. The predetermined number is a predetermined number that applies to each pixel position on the interpolated frame FH.

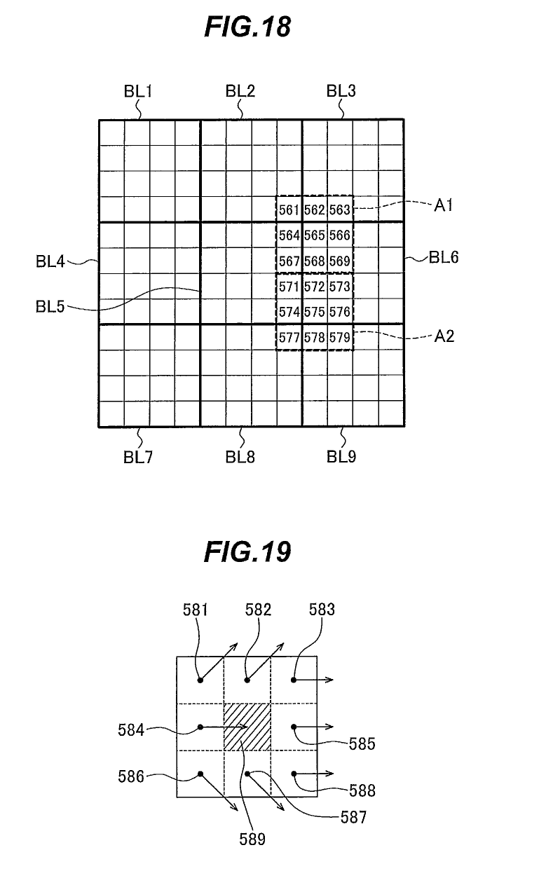

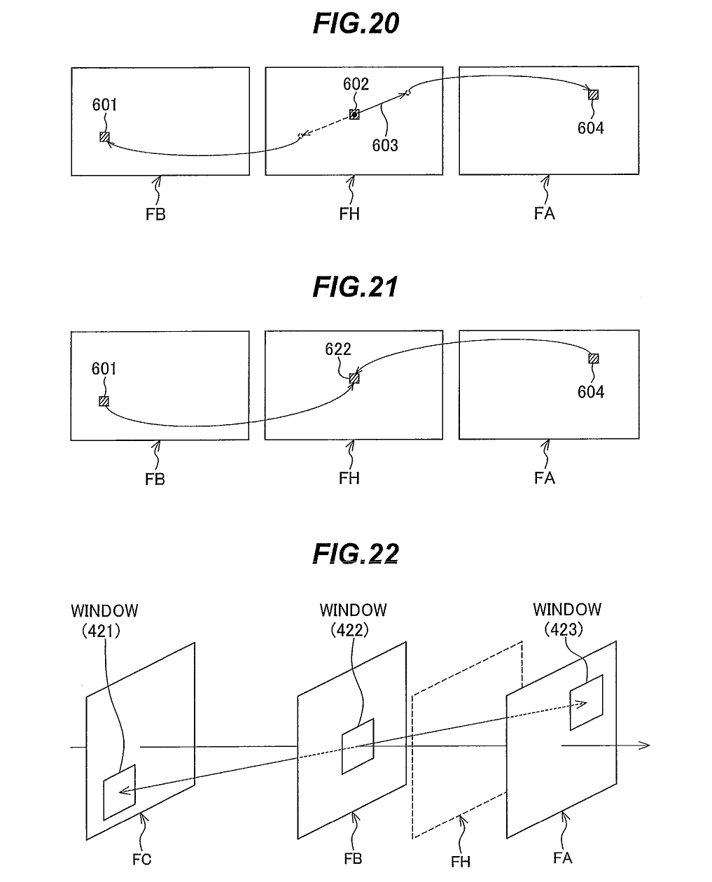

FIG. 18 shows an example in which a vacancy occurs. Pixel blocks BL1 to BL9, each consisting of 4×4 pixels, are shown in FIG. 18. Suppose that the motion vector candidates of the pixels in blocks BL1 to BL5 are all (0, 0) and the motion vector candidates of the pixels in pixel blocks BL6 to BL9 are all (2, 0). Of the pixels 561 to 569 in the 3×3 pixel area A1, pixels 561 to 564 and 567 have zero motion, while pixels 565, 566, 568, and 569 have motion (2, 0).

As explained with reference to FIG. 16, given these motion vectors, the motion destinations of pixels 561 to 564 and 567 on the interpolated frame FH are the same as their positions on the second reference frame FB, while pixel 565 moves to the position of pixel 566, pixel 568 moves to the position of pixel 569, and pixels 566 and 569 move to positions outside the 3×3 pixel area A1. The result is a vacancy, because no motion vectors give pixel positions 565 and 568 as their motion destinations. Similarly, of the pixels 571 to 579 in the 3×3 pixel area A2, a vacancy occurs at the positions of pixels 572 and 575.

Pixels where such vacancies occur are interpolated by use of the motion vector candidates of, for example, the eight neighboring pixels above, below, to the left, to the right, and diagonally adjacent to the vacancy. For example, a motion vector candidate may be determined by a majority rule. FIG. 19 illustrates a method for filling a vacancy at a pixel 589.

In the illustrated example, of the eight neighboring pixels, pixels 581 and 582 have motion vector candidate (1, 1), pixels 583, 584, 585, and 588 have motion vector candidate (1, 0), and pixels 586 and 587 have motion vector candidate (1, −1); the result of a majority decision is that (1, 0) is interpolated as a motion vector candidate for pixel 589. Alternative methods of determining motion vector candidates for pixels in vacancies include use of the mean, median, or mode values of the motion vector candidates of the eight adjacently neighboring points, or using a unique predetermined value. The eight neighboring points need not be adjacent; other neighboring pixels may be used.

As a result of this process, the motion destination determiner 62 determines, and outputs to the reference position determiner 64, at least one motion vector candidate for each pixel on the interpolated frame FH. Supplying motion vector candidates for pixels in vacancies in this way enables more accurate pixel values to be obtained for the interpolated frame than if the pixel values in the interpolated frame were to be determined from the values of surrounding pixels (for example, by taking their mean or median value).

The reference position determiner 64 determines the position (reference pixel positions) of the pixels in the first and second reference frames FA and FB that are to be referred to in order to determine the pixel value of each pixel in the interpolated frame FH on the basis of the motion vector candidates of the pixel.

More specifically, reference positions are determined by moving from each pixel 602 on the interpolated frame FH according to a vector obtained by dividing a motion vector candidate of the pixel by two to a position 604 on the first reference frame FA, and by moving by the same amount 603 but with polarity reversed to a position 601 on the second reference frame FB to obtain a reference pixel pair (604, 601) (S244).

If a plurality of motion vector candidates are obtained for a pixel on the interpolated frame FH, a number of reference pixel pairs equal to the number of motion vector candidates are obtained.

On the basis of the reference pixel pairs obtained by the reference position determiner 64, the interpolated pixel value determiner 66 determines a pixel value for each pixel in the interpolated frame FH and generates the interpolated frame FH. A pixel value in the interpolated frame FH is determined by taking the mean value of the pixels on the first reference frame FA and the second reference frame FB constituting one of the reference pixel pairs.

For example, in FIG. 21 the mean value of pixel 604 on the first reference frame FA and pixel 601 on the second reference frame FB becomes the value of pixel 622 on the interpolated frame FH.

When a plurality of motion vector candidates are obtained for a pixel in the interpolated frame FH as described above, it is necessary to select one of the plurality of reference pixel pairs.

The interpolated pixel value determiner 66 sorts the reference pixel pairs on the basis of a difference value obtained by taking the difference between the pixel values of the pixel on the first reference frame FA and the pixel on the second reference frame FB constituting each pixel pair (S245). The reference pixel pair with the smallest difference value, for example, is selected. The mean value of the selected pixel pair is then calculated (S246), and the calculated mean value is assigned as the pixel value in the interpolated frame FH (S247). The pixel value in the interpolated frame FH determined from the reference pixel pair with the smallest difference value can be considered the most reliable pixel value, and its use can be expected to improve the image quality of the interpolated frame.

The method of selecting a reference pixel pair is not limited to methods based on the magnitude of the difference between the pixel values of the pixel on the first reference frame FA and the pixel on the second reference frame FB; the selection may be made according to other factors, such as color difference information or edge information, for example.

The above process is carried out in sequence from the pixel in the top left corner of the screen to the pixel in the bottom right corner (S243, S248, S249).

Not restricting the motion vector candidates to just one until the final stage, in which the pixel values in the interpolated frame FH are determined, enables the interpolated frame FH to be generated accurately even in areas in which a plurality of motions are present.

In the embodiment described above, motion is estimated from two frames, the first reference frame FA and the second reference frame FB, but motion may be estimated from three or more frames, including the first reference frame FA and the second reference frame FB. In this case motion estimation on each level is carried out by the use of a set of three or more reference image frames.

FIG. 22 shows an example in which a frame (referred to below as the third reference frame FC) temporally adjacent to and preceding the second reference frame FB, e.g., the frame two frame periods before the first reference frame FA, is added and motion is determined from these three frames.

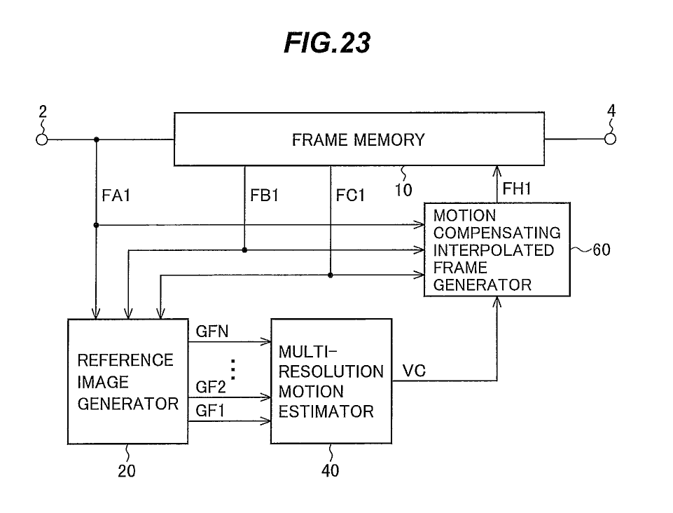

To make reference images of the first to third reference frames FA to FC, the structure in FIG. 23 is used instead of the structure in FIG. 1.

In the structure in FIG. 23, the input image is supplied to the frame memory 10, the reference image generator 20, and the motion compensating interpolated frame generator 60 as the non-reduced image FA1 of the first reference frame FA. After the non-reduced image FA1 of the first reference frame FA has been written into the frame memory 10, one frame period later it is read out as the non-reduced image FB1 of the second reference frame FB, and two frame periods later it is read out as the non-reduced image FC1 of the third reference frame FC.

The non-reduced images of the first to third reference frames FA to FC are sequentially reduced in the reference image generator 20 to generate first to N-th reference image sets GF1 to GFN.

The multi-resolution motion estimator 40 carries out motion estimation on the basis of the first to N-th reference image sets GF1 to GFN.

The motion compensating interpolated frame generator 60 uses the results of motion estimation by the multi-resolution motion estimator 40 to generate an interpolated frame, referring to the first reference image set, and writes the interpolated frame into the frame memory 10.

When the similarity calculator 44-n in each stage of the multi-resolution motion estimator 40 calculates similarity values on the basis of the sets of pixel values on the three frames, it uses combinations of pixels in a window 422 centered on a pixel on the second reference frame FB, and pixels in a window 423 centered on a pixel on the first reference frame FA and a window 421 centered on a pixel on the third reference frame FC in a point-symmetric position with respect to the pixel on the second reference frame FB.

For example, a sum SAD3 of a sum of absolute differences SAD1 of pixels in window 422 and pixels in window 423 and a sum of absolute differences SAD2 of pixels in window 422 and pixels in window 421 may be calculated, and a similarity value may be determined from the sum SAD3. Smaller values of the sum SAD3, for example, may be taken to indicate higher similarity. The addition of the third reference frame FC improves the block matching accuracy, and enables more accurate motion estimation.

### Second Embodiment

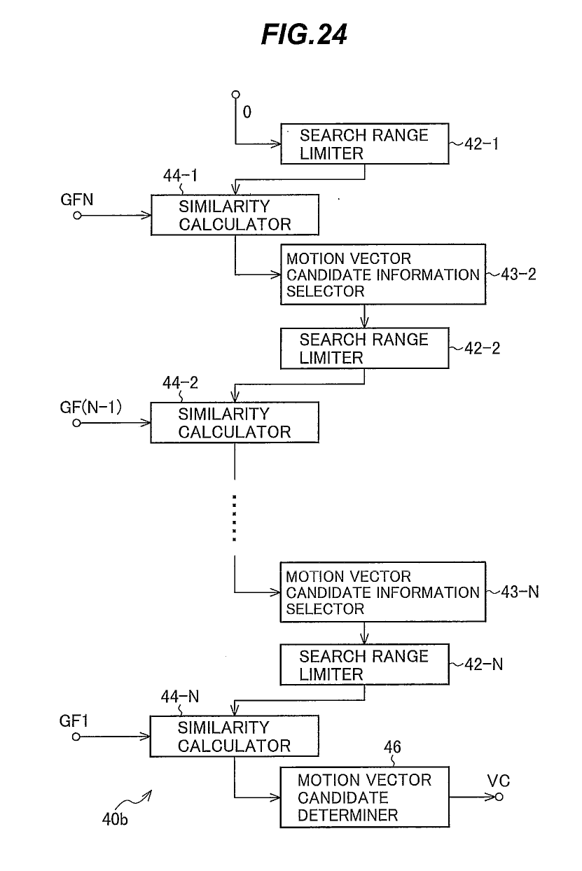

A second embodiment of the invention will be described below with reference to the drawings. FIG. 24 shows an example of the multi-resolution motion estimator 40b in the second embodiment.

The multi-resolution motion estimator 40b in FIG. 24 differs from the multi-resolution motion estimator 40 in FIG. 6 by having additional motion vector candidate information selectors 43-2 to 43-N. The multi-resolution motion estimator 40b in FIG. 24 accordingly has a plurality of search range limiters 42-1 to 42-N, a plurality of motion vector candidate information selectors 43-2 to 43-N, a plurality of similarity calculators 44-1 to 44-N, and a motion vector candidate determiner 46.

The similarity calculator in any particular stage, e.g., similarity calculator 44-n (where n is from 1 to N) inputs the corresponding reference image pair on the n-th level, which is the (N-n+1)-th reference image pair GF(N-n+1), and calculates the correlation, i.e., the similarity, of the reference images FA(N-n+1) and FB(N-n+1) constituting the pair.

Following a predetermined rule, the n-th motion vector candidate information selector 43-n (where n is from 2 to N) selects similarity tables from among the similarity tables indicating the results of motion estimation by the (n−1)-th similarity calculator 44-(n−1).

Besides selecting, from the similarity tables (information indicating motion vector candidates) of the pixels neighboring each pixel being processed, a predetermined number of similarity tables in order from the similarity table including the motion vector candidate with the greatest difference from the motion vector candidate having the largest similarity estimated for the pixel being processed, it also selects the similarity tables of the pixels in point-symmetric positions to the neighboring pixels corresponding to the selected predetermined number of similarity tables, with respect to the pixel being processed being the center of symmetry.

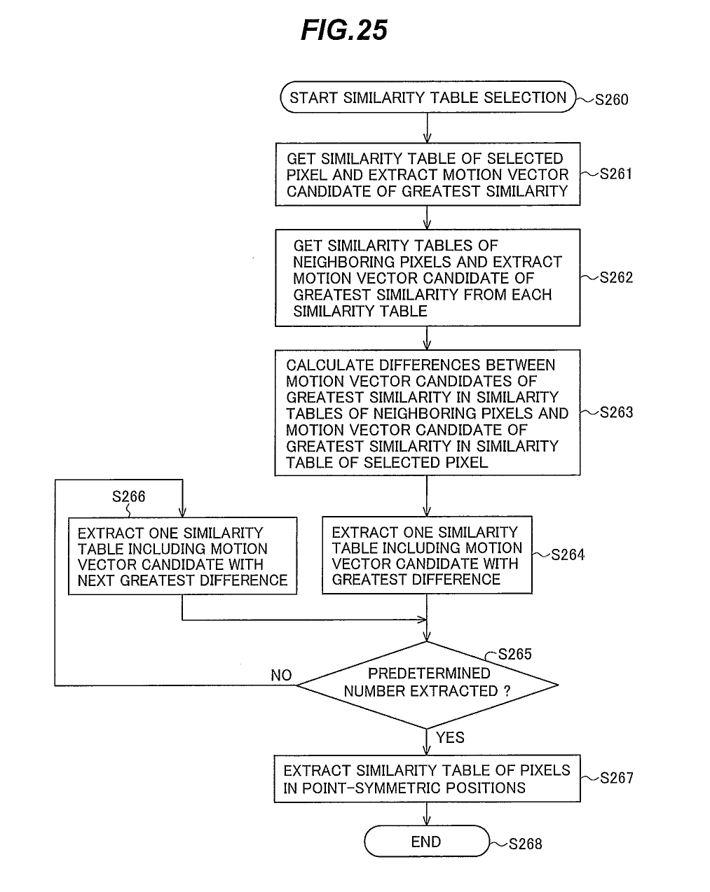

The operation of motion vector candidate information selector 43-n will be described further with reference to the flowchart in FIG. 25.

Selecting one representative point as the pixel being processed, in preparation for the similarity calculations for the selected pixel, when the similarity table selection process begins (S260), first the similarity table of the selected pixel is obtained, and the motion vector having the greatest similarity value in this table is extracted (S261).

Next the similarity tables for the pixels neighboring the selected pixel are obtained and the motion vectors having the greatest similarity values in these tables are extracted (S262).

The similarity tables obtained in steps S261 and S262 by the motion vector candidate information selector 43-n in each stage are generated and configured by the similarity calculator 44-(n−1) in the preceding stage.

Next the difference between the motion vector candidates extracted in step S262 (the motion vector candidates with the greatest similarity in each of the similarity tables of the neighboring pixels) and the motion vector candidate extracted in step S261 (the motion vector candidate with the greatest similarity in the similarity table of the selected pixel) is determined (S263).

Next, from among the similarity tables of the neighboring pixels, one similarity table including the motion vector candidate with the greatest difference determined in step S263 is extracted (S264).

A decision is now made as to whether the number of similarity tables extracted so far has reached a prescribed number or not (S265); if the prescribed number has not been reached, the process proceeds to step S266, one similarity table including the motion vector candidate with the greatest difference is selected from those of the similarity tables of neighboring pixels that have not been extracted yet, and then the process returns to step S265.

When the prescribed number is reached in step S265, the similarity tables of the pixels in point-symmetric positions to each of the pixels corresponding to the similarity tables extracted in steps 264 and 266 are extracted, the pixel being processed being the center of symmetry (S267), and the process ends (S268).

The similarity table of the pixel being processed and all of the similarity tables extracted in steps S264, S266, and S267 are supplied as the similarity tables selected by motion vector candidate information selector 43-n to the search range limiter 42-n in the same stage.

The search range limiter in each stage other than the initial stage, i.e., the search range limiter 42-n (where n is from 2 to N), determines the search range on the basis of the motion vector candidate information, e.g., the similarity tables, selected by the n-th motion vector candidate information selector 43-n (n being from 2 to N).

The search range limiter 42-1 in the initial stage is given an empty similarity table (represented by ‘0’ in FIG. 6) because there is no motion vector candidate information selector in the same stage and no similarity calculator in the preceding stage.

The n-th similarity calculator 44-n (n being from 1 to N) carries out similarity calculations on corresponding pixels for motion vectors in the search range determined by the n-th search range limiter 42 (on the pixel being processed on the second reference frame FB and the pixels on the first reference frame FA in the positions of the motion destinations equivalent to the motion vector candidates when based at the position of the pixel being processed), and performs motion estimation on the basis of the calculated results. That is, by obtaining similarity values of pixel pairs consisting of a pixel in the second reference frame FB and a pixel in the first reference frame FA, it determines the position (relative position, motion vector) on the first reference frame FA to which each pixel in the second reference frame FB has moved.

The similarity calculators 44-n and the other blocks other than the motion vector candidate information selectors 43-n (n being from 2 to N) and the search range limiters 42-n (n being from 1 to N) in the second embodiment are as described in the first embodiment.

In the first embodiment, in motion estimation using reference image pairs at each resolution level, for improved accuracy when a search range was determined for each pixel being processed, as the motion estimation results for each pixel that was processed using the reference image pair at the next lower resolution level, in addition to the similarity table of the pixel being processed, the similarity tables of neighboring representative points (for example, adjacent representative points) were also used.

The motion vector candidate information selectors 43-n (n being from 2 to N) used in the second embodiment do not use all the similarity tables (motion vector candidate information) corresponding to neighboring points, but limit the usage to a prescribed number of similarity tables (motion vector candidate information) corresponding to representative points neighboring each pixel being processed.

In the following description, the neighboring representative points will be the four adjacent representative points above, below, to the left of, and to the right of the pixel being processed, and two similarity tables will be selected, but the neighboring representative points are not limited to the points above, below, to the left, and to the right, and the number of similarity tables selected is not limited to two.

The motion vector candidate information selector 43-n (n being from 2 to N) first selects, by a criterion described later, one of the similarity tables of the neighboring representative points including an optimal motion vector candidate. It also selects the similarity table of the representative point at the point-symmetric position to the representative point corresponding to the similarity table including the optimal motion vector candidate, the pixel being processed being the center of symmetry. The two similarity tables thus selected are output to the motion vector candidate information selector 43-n.

The search range limiter in each stage other than the first stage, e.g., the n-th search range limiter 42-n (where n is from 2 to N) determines a search range based on the similarity tables selected by the motion vector candidate information selector 43-n in the same stage. More specifically, search range limiter 42-n sets predetermined ranges centered on the motion destination positions corresponding to one or two or more motion vector candidates included in the similarity tables selected by the motion vector candidate information selector 43-n, for example, ranges within a predetermined distance, as the search range.

The operation of the search range limiter 42-1 in the first stage is as described in the first embodiment.

Taking the passing of similarity tables from motion estimation by the 1/16 reduced image shown in FIG. 10 to motion estimation by the ¼ reduced image shown in FIG. 11 as an example, if the four adjacent representative points above, below, to the left, and to the right are used, then in addition to the similarity table of representative point 451 (the pixel being processed) in the second reference frame FB in the 1/16 reduced image shown in FIG. 10, if the representative point (neighboring pixel) corresponding to the similarity table including the optimal motion vector candidate is representative point 454b, then three similarity tables, including that of the representative point 452g in the point-symmetric position, are passed to the search range limiter.

The criterion for selecting the similarity table including the optimal motion vector candidate will now be described.

It is desirable for the search range limited on the basis of the similarity table of the pixel being processed and the search ranges limited on the basis of the similarity tables of the selected neighboring pixels to differ, or to overlap as little as possible. The similarity table including the motion vector candidate with the greatest similarity that differs the most, among the motion vector candidates with the greatest similarity included in the similarity tables of the neighboring representative points, from the motion vector candidate with the greatest similarity included in the similarity table of the pixel being processed is therefore selected as the similarity table including the optimal motion vector.

By selecting, from the similarity tables including motion vector candidates estimated for neighboring pixels, the similarity table including a motion vector candidate of greatest similarity that differs most greatly from the motion vector candidate of greatest similarity included in the similarity table of the pixel being processed, it is possible to obtain a search range that encompasses more varied motion.

By also selecting the similarity table of the pixel in the position that is point-symmetric to the neighboring pixel corresponding to the similarity table including the motion vector candidate (the optimal motion vector candidate) of greatest similarity that differs the most greatly, the pixel being processed being the center of symmetry, in the vicinity of a boundary between two regions with differing motion, it is possible to select a representative point in the point-symmetric position straddling the boundary, thus setting a search range on the basis of motion vector candidates on both sides of the boundary, which is expected to improve the accuracy of motion vector detection near such boundaries.

The similarity table including the optimal motion vector candidate is not limited to a single table; a plurality may be selected, and this embodiment may be practiced with selection methods other than the method described above. For example, from the similarity tables of all the neighboring representative points, the similarity table having the highest similarity may be selected.

As described above, by making an appropriate selection of the similarity tables of the neighboring representative points without using all of them when determining the search range, it is possible to prevent the search range from becoming needlessly large, and to reduce the amount of processing. By keeping the search range from becoming needlessly large, it is also possible to reduce erroneous motion estimation.

### Third Embodiment

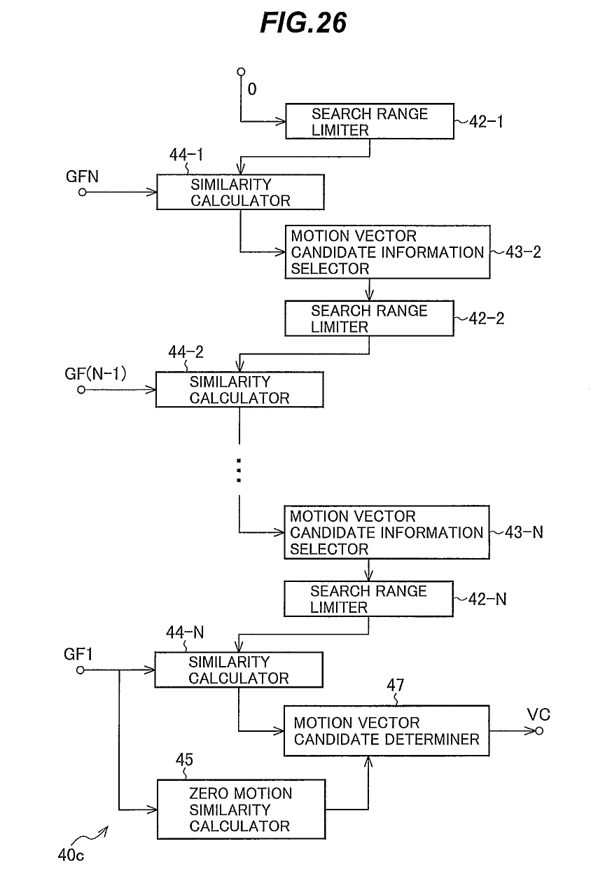

A third embodiment of the invention will be described below with reference to the drawings. FIG. 26 shows an example of the multi-resolution motion estimator 40c in the third embodiment.

The multi-resolution motion estimator 40c in FIG. 26 differs from the multi-resolution motion estimator 40b in FIG. 24 by having an additional zero motion similarity calculator 45, and by using a different motion vector candidate determiner 47 in place of the motion vector candidate determiner 46. The multi-resolution motion estimator 40c shown in FIG. 26 accordingly has a plurality of search range limiters 42-1 to 42-N, a plurality of motion vector candidate information selectors 43-2 to 43-N, a plurality of similarity calculators 44-1 to 44-N, a zero motion similarity calculator 45, and a motion vector candidate determiner 47.

The zero motion similarity calculator 45 calculates similarities corresponding to zero motion vectors. It accordingly operates similarly to a similarity calculator that calculates similarities for motion vector candidates in a search range, centered on the pixel being processed, measuring one pixel per side (including only the pixel being processed), that is, in a 1×1-pixel range (a range consisting only of the pixel being processed), and outputs a similarity table (having only one element) corresponding to a motion vector with zero motion.

When the similarity in the similarity table received from the zero motion similarity calculator 45 exceeds a predetermined threshold value, the motion vector candidate determiner 47 treats all motion vectors as 0 (motionless). If the similarity is lower than the predetermined threshold value, the motion vector candidates are determined in the same way as by the motion vector candidate determiner 46 in the second embodiment.

Finding motionless similarities and setting the motion vector candidates to zero as necessary as described above enables motion to be estimated more accurately when there are motionless objects.

The invention has been described above as a frame interpolation apparatus, but the frame interpolation method executed by the apparatus is also part of the invention. The invention can also be practiced as a program for executing the processing in each procedure or step carried out in the above frame interpolation apparatus or frame interpolation method, and as a computer-readable recording medium in which the program is recorded.

### Industrial Applicability

Exemplary applications of the present invention include frame frequency conversion in television and frequency conversion in commercial, institutional, or industrial monitor. Applications to blur correction and other types of image processing that make use of motion vectors are also possible.

A few variations have been mentioned above, but those skilled in the art will recognize that further variations are possible within the scope of the invention, which is defined in the appended claims.

What is claimed is:

1. A frame interpolation apparatus for generating an interpolated frame between a first frame and a second frame in a video signal, the second frame temporally preceding the first frame, the frame interpolation apparatus comprising:
a reference image generator for receiving image signals of the first frame and the second frame and generating therefrom a plurality of sets of reference images, the reference images in each one of the sets having mutually identical resolution, the reference images in different ones of the sets having different resolutions;
a motion estimation unit for performing motion estimation based on the plurality of sets of reference images; and
an interpolated frame generator for generating an image signal of the interpolated frame, each pixel on the interpolated frame being based on at least one motion vector candidate obtained as a result of motion estimation performed by the motion estimation unit using the set of reference images of highest resolution; wherein
the motion estimation unit sequentially generates information representing results of motion estimation by proceeding sequentially from motion estimation using the reference images of lowest resolution to motion estimation using the reference images of the highest resolution; and
in performing motion estimation by using the reference images of each resolution, the motion estimation unit determines a search range, for each pixel processed on the second frame, by
using information indicating a motion vector candidate obtained for the pixel being processed as a result of motion estimation performed using the set of reference images of next lower resolution, and
also using information indicating a motion vector candidate obtained for a pixel neighboring the pixel being processed as a result of motion estimation performed using the set of reference images of the next lower resolution.

2. The frame interpolation apparatus of claim 1, wherein the motion estimation unit, in determining the search range in the motion estimation performed by using the reference images of each resolution, determines, for each pixel processed in the second frame, a search range including a prescribed range centered on a position to which the pixel being processed moved according to a motion vector candidate estimated for the pixel being processed using the set of reference images of the next lower resolution, and a prescribed range centered on a position to which the pixel being processed moved according to a motion vector candidate estimated for a pixel neighboring the pixel being processed using the set of reference images of the next lower resolution.

3. The frame interpolation apparatus of claim 1, wherein the motion estimation unit further comprises a motion vector candidate information selector for selecting a predetermined number of items of information from information indicating motion vector candidates estimated for pixels neighboring the pixel being processed using the set of reference images of the next lower resolution, the selected items of information being used to determine the search range for the pixel being processed.

4. The frame interpolation apparatus of claim 3, wherein the motion vector candidate information selector selects,
from the information indicating motion vector candidates estimated for the pixels neighboring the pixel being processed,
a certain number of items of information including motion vector candidates of greatest similarity that differ most greatly from the motion vector candidate of greatest similarity among the motion vector candidates estimated for the pixel being processed, and
information indicating motion vector candidates estimated for the pixels in point-symmetric positions to the neighboring pixels to which the selected certain number of items of information pertain, the pixel being processed being the center of symmetry.

5. The frame interpolation apparatus of claim 4, wherein the motion estimation unit further comprises a search range limiter for determining the search range according to the information indicating a plurality of the motion vector candidates selected by the motion vector candidate information selector.

6. The frame interpolation apparatus of claim 5, wherein the search range limiter determines, as the search range, a region including prescribed ranges centered on a plurality of positions to which the pixel being processed moved according to motion vector candidates indicated by the information selected by the motion vector candidate information selector.

7. The frame interpolation apparatus of claim 1, wherein the reference image generator generates the plurality of sets of references images by repeatedly reducing the first frame and the second frame by a predetermined reduction ratio, taking mean values of a plurality of pixels as pixel values in the reduced reference images.

8. The frame interpolation apparatus of claim 1, wherein the reference image generator also receives an image signal of a third frame temporally preceding the second frame and generates, in each one of the sets of reference images, a reference image derived from the third frame as well as reference images derived from the first and second frames.

9. The frame interpolation apparatus of claim 1, wherein when the interpolated frame includes a pixel that is not a motion destination of any pixel on the first frame according to any motion vector candidate, the interpolated frame generator obtains a motion vector candidate for the pixel in the interpolated frame by interpolation, using motion vector candidates obtained for pixels neighboring the pixel in the interpolated frame.

10. The frame interpolation apparatus of claim 1, wherein when the motion estimation unit outputs two or more motion vector candidates for a pixel on the interpolated frame, the interpolated frame generator selects, from among pairs of reference pixels determined according to the two or more motion vector candidates, a pair of reference pixels with pixel values that differ least from each other, and determines a pixel value for the pixel on the interpolated frame from the pixel values of the selected pair of reference pixels.

11. A frame interpolation method for generating an interpolated frame between a first frame and a second frame in a video signal, the second frame temporally preceding the first frame, the frame interpolation method comprising:
receiving image signals of the first frame and the second frame and generating therefrom a plurality of sets of reference images, the reference images in each one of the sets having mutually identical resolution, the reference images in different ones of the sets having different resolutions;
performing motion estimation based on the plurality of sets of reference images; and
generating an image signal of the interpolated frame, each pixel on the interpolated frame being based on at least one motion vector candidate obtained as a result of the motion estimation performed using the set of reference images of highest resolution; wherein
performing the motion estimation further comprises sequentially generating information representing results of motion estimation by proceeding sequentially from motion estimation using the reference images of lowest resolution to motion estimation using the reference images of the highest resolution; and
performing the motion estimation by using the reference images of each resolution further comprises determining a search range, for each pixel processed on the second frame, by
using information indicating a motion vector candidate obtained for the pixel being processed as a result of motion estimation performed using the set of reference images of next lower resolution, and
also using information indicating a motion vector candidate obtained for a pixel neighboring the pixel being processed as a result of motion estimation performed using the set of reference images of the next lower resolution.

12. The frame interpolation method of claim 11, wherein the search range determined for each pixel processed in the second frame in the motion estimation performed by using the reference images of each resolution further includes a prescribed range centered on a position to which the pixel being processed moved according to a motion vector candidate estimated for the pixel being processed using the set of reference images of the next lower resolution, and a prescribed range centered on a position to which the pixel being processed moved according to a motion vector candidate estimated for a pixel neighboring the pixel being processed using the set of reference images of the next lower resolution.

13. The frame interpolation method of claim 11, wherein performing the motion estimation further comprises selecting a predetermined number of items of information from information indicating motion vector candidates estimated for pixels neighboring the pixel being processed using the set of reference images of the next lower resolution, and using the selected items of information.

14. The frame interpolation method of claim 13, wherein the predetermined number of items of information include:
a certain number of items of information including motion vector candidates of greatest similarity that differ most greatly from the motion vector candidate of greatest similarity among the motion vector candidates estimated for the pixel being processed; and
information indicating motion vector candidates estimated for the pixels in point-symmetric positions to the neighboring pixels to which the selected certain number of items of information pertain, the pixel being processed being the center of symmetry.

15. The frame interpolation method of claim 14, wherein the search range is determined according to the selected predetermined number of items of information.

16. The frame interpolation method of claim 15, wherein the search range includes prescribed ranges centered on a plurality of positions to which the pixel being processed moved according to motion vector candidates indicated by the selected predetermined number of items of information.

17. The frame interpolation method of claim 11, wherein receiving the image signals of the first frame and the second frame and generating therefrom the plurality of sets of references images further comprises repeatedly reducing the first frame and the second frame by a predetermined reduction ratio, taking mean values of a plurality of pixels as pixel values in the reduced reference images.

18. The frame interpolation method of claim 11, wherein receiving the image signals of the first frame and the second frame and generating therefrom the plurality of sets of references images further comprises receiving an image signal of a third frame temporally preceding the second frame and generating, in each one of the sets of reference images, a reference image derived from the third frame as well as reference images derived from the first and second frames.

19. The frame interpolation method of claim 11, wherein when the interpolated frame includes a pixel that is not a motion destination of any pixel on the first frame according to any motion vector candidate, generating the image signal of the interpolated frame further comprises obtaining a motion vector candidate for the pixel in the interpolated frame by interpolation, using motion vector candidates obtained for pixels neighboring the pixel in the interpolated frame.

20. The frame interpolation method of claim 11, wherein when two or more motion vector candidates are obtained for a pixel on the interpolated frame, generating an image signal of the interpolated frame includes selecting, from among pairs of reference pixels determined according to the two or more motion vector candidates, a pair of reference pixels with pixel values that differ least from each other, and determining a pixel value for the pixel on the interpolated frame from the pixel values of the selected pair of reference pixels.

21. A computer-readable recording medium storing a program executable to perform frame interpolation by the method of claim 11.
